(19) United States
(12) Patent Application Publication
(10) Pub. No.: US 2008/0093809 A1
(43) Pub. Date: Apr. 24, 2008

(54) Structure of gasket for separator of fuel cell

(75) Inventors: Young Bum Kum, Seoul (KR); Tae Won Lim, Seoul (KR); Sae Hoon Kim, Gyeonggi-do (KR); Yu Chang Yang, Gyeonggi-do (KR)

Correspondence Address: EDWARDS ANGELL PALMER & DODGE LLP, P.O. BOX 55874, BOSTON, MA, 02205, US

(73) Assignee: Hyundai Motor Company, Seoul (KR)

(21) Appl. No.: 11/600,965

(22) Filed: Nov. 15, 2006

(30) Foreign Application Priority Data
Sep. 7, 2006 (KR) 10-2006-0086443

(51) Int. Cl. F02F 11/00

(52) U.S. Cl. 277/598

(57) ABSTRACT

The present invention relates to a gasket structure for use in a fuel cell having a separator which defines at each of the both ends thereof a hydrogen manifold, an air manifold, an antifreezing solution manifold between the hydrogen manifold and the air manifold, the structure comprising a plurality of gasket parts a portion of which is open toward the outside of the separator so as to prevent antifreezing solution leaked from the antifreezing solution manifold from flowing into the hydrogen manifold and the air manifold.

### CROSS-REFERENCE TO RELATED APPLICATION

This application claims priority to and the benefit of Korean Patent Application No. 10-2006-0086443 filed in the Korean Intellectual Property Office on Sep. 7, 2006, the entire contents of which are incorporated herein by reference.

### BACKGROUND OF THE INVENTION

(a) Field of the Invention

The present invention relates to a gasket structure attached to a separator of a fuel cell for vehicles.

(b) Description

Generally, a fuel cell is comprised of electrodes generating an electrochemical reaction, an electrolyte membrane, and a separator supporting the electrodes and the electrolyte membrane.

A polymer electrolyte membrane fuel cell has a high efficiency, a high current density, a high output density, and a short starting time. In addition, the polymer electrolyte membrane fuel cell has an advantage in that regulations of corrosion and an electrolyte are not necessary since a solid electrolyte is Used. Also, it is an environmentally friendly power source yielding pure water as an emission. For these reasons, various researches on polymer electrolyte membrane fuel cells have been made in the field of the car industry.

A polymer electrolyte membrane fuel cell is a device that generates electricity while generating water and heat through an electrochemical reaction of hydrogen and oxygen. In the cell, supplied hydrogen is separated into a hydrogen ion and an electron by a catalyst disposed on the anode. The separated hydrogen ion moves to the cathode via an electrolyte membrane. Supplied oxygen and electron supplied through an outer line are then coupled so as to generate water, thereby generating electrical energy. A theoretical voltage generated by this process is about 1.3V. The reaction equation is as follows.

Anode: H₂→2H⁺+2e

Cathode: 1/2O₂+2H⁺+2e→H₂O

An actual fuel cell for vehicles is required to produce a higher voltage, and in order to produce a higher voltage, a number of unit fuel cells need to be accumulated. A set of accumulated fuel cells is called a stack.

A separator is used to cool the fuel cell by removing heat generated in the stack. The electric conductivity of a separator is high so as to effectively transmit electrons. If a separator having a high electric conductivity is used, distilled water having a low electric conductivity should be used as coolant.

The fuel cell includes a reaction region where hydrogen and air react. It also includes a sealing means for preventing hydrogen, air, and coolant from leaking from respective manifolds.

A fuel cell is required to conduct or stop such electrochemical reaction frequently and repeatedly. As a result, a cycle of contraction and expansion entails.

A sealing structure of a fuel cell should be able to maintain its sealing characteristic under such frequent contraction and expansion. In order to prevent a fatigue failure, a stress distribution on respective elements of the fuel cell should be uniform during the cycle of contraction and expansion.

Recently, in order to allow the fuel cell to operate at a sub-zero temperature, rather than using a heater for heating the stack, antifreezing solutions have been used instead of coolants.

However, the conventional systems utilizing antifreezing solution have a drawback that a membrane-electrode assembly can be contaminated and its ion exchanging characteristic can be reduced, thereby deteriorating overall performance of the fuel cell.

In order to solve this problem, gaskets are proposed to be disposed around electrodes and manifolds. For example, a silicon sheet or a Teflon sheet that is intensified by glass fiber has been widely used as a gasket for sealing fuel cells. Although such gasket can be manufactured by a relatively simple process with less or no thickness variance, it still poses a drawback that antifreezing solution can contaminate the fuel cell because its sealing effect is not sufficient.

There is thus a need for an improved gasket structure that can prevent antifreezing solution from contaminating a fuel cell.

The information disclosed in this Background of the Invention section is only for enhancement of understanding of the background of the invention and should not be taken as an acknowledgement or any form of suggestion that this information forms the prior art that is already known to a person skilled in the art.

### SUMMARY OF THE INVENTION

In one aspect, the present invention provides a gasket structure for use in a fuel cell having a separator which defines at each of the both ends thereof a hydrogen manifold, an air manifold, an antifreezing solution manifold between the hydrogen manifold and the air manifold, the structure comprising a plurality of gasket parts a portion of which is open toward the outside of the separator so as to prevent antifreezing solution leaked from the antifreezing solution manifold from flowing into the hydrogen manifold and the air manifold.

In another aspect, motor vehicles are provided that comprise a described gasket structure.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like. The present gasket structures will be particularly useful with a wide variety of motor vehicles.

Other aspects of the invention are discussed infra.

### BRIEF DESCRIPTION OF THE DRAWINGS

FIG. 1 is a drawing showing a first gasket part and a second gasket part of a structure of a gasket for a separator of a fuel cell according to an exemplary embodiment of the present invention.

FIG. 2 is a drawing showing a variant of a first gasket part of a structure of a gasket for a separator of a fuel cell according to an exemplary embodiment of the present invention.

FIG. 3 is a drawing showing a variant of a second gasket part of a structure of a gasket for a separator of a fuel cell according to an exemplary embodiment of the present invention.

FIG. 4A and FIG. 4B are drawings showing mode of operation of a first gasket part and a second gasket part of a structure of a gasket for a separator of a fuel cell according to an exemplary embodiment of the present invention.

Reference numerals set forth in the Drawings includes reference to the following elements as further discussed below:

10: separator

100: first gasket part

110: first gasket

120: second gasket

130: first bridge

200: second gasket part

210: third gasket

220: fourth gasket

230: second bridge

### DETAILED DESCRIPTION

As discussed above, the present invention provides a gasket structure for use in a fuel cell having a separator which defines at each of the both ends thereof a hydrogen manifold, an air manifold, an antifreezing solution manifold between the hydrogen manifold and the air manifold, the structure comprising a plurality of gasket parts a portion of which is open toward the outside of the separator so as to prevent antifreezing solution leaked from the antifreezing solution manifold from flowing into the hydrogen manifold and the air manifold.

A preferred gasket structure of the present invention may comprise a first gasket part including (a) a first gasket installed to a front surface of the separator and adhering closely to an outer edge of the antifreezing solution manifold, and (b) a second gasket adhering closely to outer edges of the hydrogen and the air manifolds and to an edge of the separator, wherein a portion of the second gasket disposed corresponding to the position of the antifreezing solution manifold is opened toward the outside of the separator.

Another preferred gasket structure of the present invention may further comprise a second gasket part including (a) a third gasket installed to a rear surface of the separator and adhering closely to outer edges of the hydrogen manifold and the air manifold, and (b) a fourth gasket formed along an outer portion of the antifreezing solution manifold and along inner edges of the hydrogen and the air manifolds.

In a preferred embodiment of the present invention, a first bridge may suitably be formed between the first gasket and the second gasket of the first gasket part so as to connect the first and the second gaskets together.

In another preferred embodiment of the present invention, a second bridge may preferably be formed between the third gasket and the fourth gasket of the second gasket part so as to connect the third and the fourth gaskets together.

Suitably, first, second, third and fourth gaskets of a preferred gasket structure may be formed separately and independently.

In another aspect, the present invention provides motor vehicles comprising the gasket structure as described above.

Reference will now be made in detail to the preferred embodiment of the present invention, examples of which are illustrated in the drawings attached hereinafter, wherein like reference numerals refer to like elements throughout. The embodiments are described below so as to explain the present invention by referring to the figures.

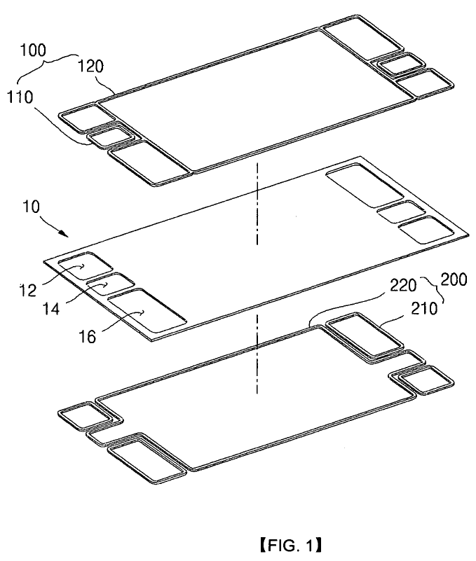

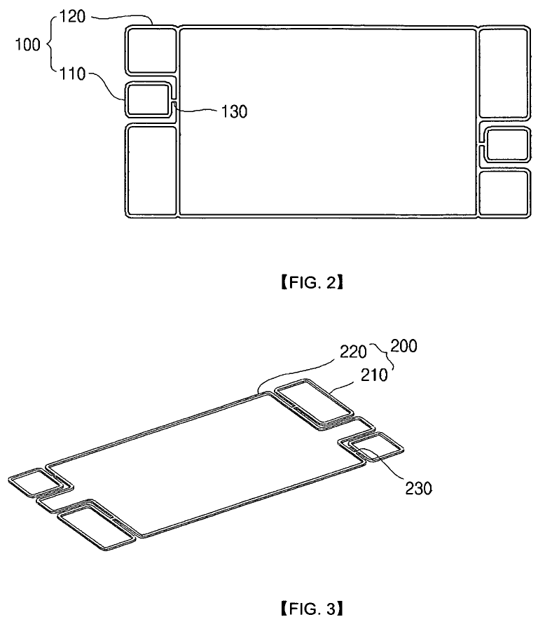

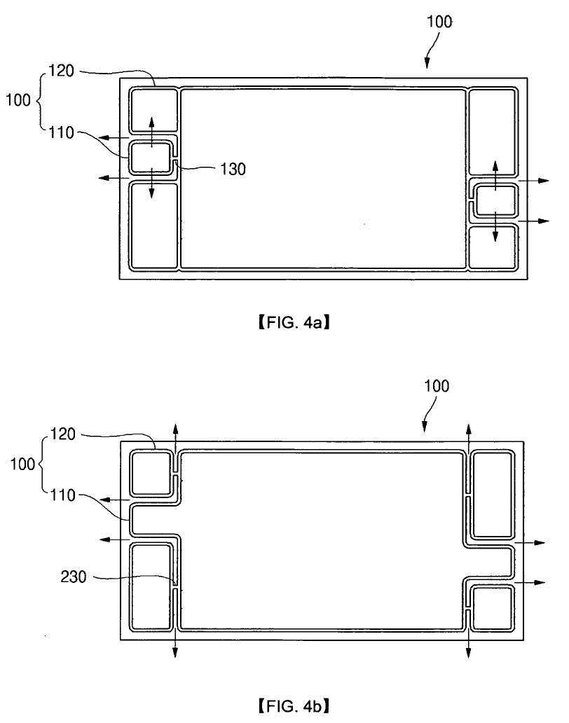

FIG. 1 is a drawing showing a first gasket part and a second gasket part of a structure of a gasket for a separator of a fuel cell according to an exemplary embodiment of the present invention, FIG. 2 is a drawing showing a variant of a first gasket part of a structure of a gasket for a separator of a fuel cell according to an exemplary embodiment of the present invention, FIG. 3 is a drawing showing a variant of a second gasket part of a structure of a gasket for a separator of a fuel cell according to an exemplary embodiment of the present invention, and FIG. 4A and FIG. 4B are drawings showing mode of operation of a first gasket part and a second gasket part of a structure of a gasket for a separator of a fuel cell according to an exemplary embodiment of the present invention.

Referring to FIG. 1 to FIG. 2, a separator 10 has a hydrogen manifold 12, an air manifold 16, and an antifreezing solution manifold 14 between the hydrogen manifold 12 and the air manifold 16 at each of both ends thereof. Preferably, a first gasket part 100 may be installed to the front surface of the separator 10. First gasket part 100 may comprise a first gasket 110 adhering closely to an outer edge of the antifreezing solution manifold 14. It may further comprise a second gasket 120 adhering closely to outer edges of the hydrogen and the air manifolds 12 and 16 and to an edge of the separator 10. A portion of the second gasket 120 corresponding to the position of the antifreezing solution manifold 1 may be configured to be open toward the outside of the separator 10 such that a membrane-electrode assembly can be prevented from being contaminated by antifreezing solution leaked from the antifreezing solution manifold 14.

Another preferred gasket structure may further have a second gasket part 200. Preferably, second gasket part may comprise a third gasket 210 installed to a rear surface of the separator 10 and adhering closely to outer edges of the hydrogen and the air manifolds 12 and 16. It may further comprise a fourth gasket 220 formed along an outer portion of the antifreezing solution manifold 14 formed and along inner edges of the hydrogen manifold 12 and the air manifold 16.

In still another preferred gasket structure of the present invention, a first bridge 130 may suitably be formed between the first and the second gaskets 110 and 120 of the first gasket part 100 so as to connect the first and the second gaskets 110 and 120 together.

In a further embodiment of the present invention, a second bridge 230 may suitably be formed between the third and the fourth gaskets 210 and 220 of the second gasket part 200 so as to connect the third and the fourth gaskets 210 and 220 together.

In the above embodiments of the present invention, first, second, third and fourth gaskets may be formed independently and separately.

Mode of operation of the gasket structures according to a preferred embodiment of the present invention will be explained hereinafter with reference to the accompanying drawings.

Referring to FIG. 4A, if antifreezing solution passing through the antifreezing solution manifold 14 leaks from the first gasket 110 in the state that the first and the second gasket parts 100 and 200 adhere closely to the front and the rear surfaces of the separator 10, the leaked antifreezing solution may reach the second gasket 120 via the first gasket 110. As a result, the antifreezing solution may permeate a membrane-electrode assembly (MEA), thereby contaminating the membrane-electrode assembly.

According to preferred embodiments of the present invention, the leaked antifreezing solution can be discharged to the outside of the separator 10 without permeating the membrane-electrode assembly since a portion of the second gasket 120 positioned corresponding to the antifreezing solution manifold 14 is opened toward the outside of the separator 10.

Referring to FIG. 4B, in the rear side of the separator 10, the antifreezing solution flows in a region between the third gasket 210 and the fourth gasket 220, so that the antifreezing solution leaked from the antifreezing solution manifold 14 cannot move to the air manifold 16 and the hydrogen manifold 12. Accordingly, the membrane-electrode assembly can be prevented from being contaminated by the leaked antifreezing solution.

Preferably, the antifreezing solution may be discharged to the outside of the separator 10 in the directions of arrows shown in FIG. 4A and FIG. 4B to prevent contamination by the leaked antifreezing solution.

In another embodiment of the present invention, a first bridge 130 may be formed in the first gasket part 100, and the second bridge 230 may be formed in the second gasket part 200. With first and second bridges, a preferred gasket structure of the present invention can be more securely and easily attached to the front and the rear surfaces of a separator. Methods and modes of the attachment will not be explained here as they are obvious to those skilled in the art.

As described above, gasket structures of the present invention can prevent the membrane-electrode assembly and the stack from being contaminated by the leaked antifreezing solution in a fuel cell.

In addition, gasket structures of the present invention also can effectively radiate heat of the stack, thereby enhancing the overall performance of the stack and preventing possible malfunctions of the stack.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A gasket structure for use in a fuel cell having a separator which defines at each of the both ends thereof a hydrogen manifold, an air manifold, an antifreezing solution manifold between the hydrogen manifold and the air manifold, the structure comprising a plurality of gasket parts a portion of which is open toward the outside of the separator so as to prevent antifreezing solution leaked from the antifreezing solution manifold from flowing into the hydrogen manifold and the air manifold.

2. The gasket structure of claim 1, comprising a first gasket part including (a) a first gasket installed to a front surface of the separator and adhering closely to an outer edge of the antifreezing solution manifold, and (b) a second gasket adhering closely to outer edges of the hydrogen and the air manifolds and to an edge of the separator, wherein a portion of the second gasket disposed corresponding to the position of the antifreezing solution manifold is opened toward the outside of the separator.

3. The gasket structure of claim 2, further comprising a second gasket part including (a) a third gasket installed to a rear surface of the separator and adhering closely to outer edges of the hydrogen manifold and the air manifold, and (b) a fourth gasket formed along an outer portion of the antifreezing solution manifold and along inner edges of the hydrogen and the air manifolds.

4. The gasket structure of claim 2, wherein a first bridge is formed between the first gasket and the second gasket of the first gasket part so as to connect the first and the second gaskets together.

5. The gasket structure of claim 3, wherein a second bridge is formed between the third gasket and the fourth gasket of the second gasket part so as to connect the third and the fourth gaskets together.

6. The gasket structure of claim 4, wherein the first, the second, the third and the fourth gaskets are formed independently and separately.

7. A motor vehicle comprising the gasket structure of claim 1.
